(19) United States
(12) Patent Application Publication
(10) Pub. No.: US 2025/0305084 A1
(43) Pub. Date: Oct. 2, 2025

(54) SYSTEMS AND METHODS USING ELECTRIC PERMITTIVITY MEASUREMENTS OF HYDROMETALLURGICAL HEAP LEACHING

(71) Applicant: FREEPORT MINERALS CORPORATION, Phoenix, AZ (US)

(72) Inventor: Robert Lewis Zwick, Phoenix, AZ (US)

(73) Assignee: FREEPORT MINERALS CORPORATION, Phoenix, AZ (US)

(21) Appl. No.: 18/622,672

(22) Filed: Mar. 29, 2024

(51) Int. Cl. C22B 3/02; C22B 15/00; G01N 22/00

(52) U.S. Cl. CPC C22B 3/02; C22B 15/0065; G01N 22/00

(57) ABSTRACT

A method and system for real-time monitoring and optimization of a heap leaching process using permittivity measurements is provided. The method includes deriving a relationship between a measured permittivity of an ore and a measured metal concentration of the ore, placing a plurality of antennas configured to measure permittivity in a leaching heap of the ore, taking a plurality of permittivity measurements of the leaching heap during a leaching process, and using the derived relationship and the permittivity measurements of the leaching heap to estimate an overall metal recovery of the leaching process.

### FIELD OF INVENTION

The present invention generally relates to improvements to the control of the heap leaching process, and more particularly to optimizing the heap leaching process by using electric permittivity measurement systems and methods to enable real-time monitoring of the leaching process.

### BACKGROUND

Hydrometallurgical treatment of metal-bearing materials, such as ores, metal-bearing concentrates, and other metal-bearing substances, has been a well-established practice for many years. Leaching of metal-bearing materials is a fundamental process utilized to extract metals from metal-bearing materials, such as copper-containing ores. In general, a leaching process may consist of crushing, agglomeration, and stacking of the ore material in a leach stockpile or a “heap.” Then, the ore is leached in the heap with an aqueous solution, and a metal-bearing or “pregnant” leach solution (PLS) is collected. From the PLS, dissolved metal values can be recovered to produce a saleable metal product.

The first step in a typical leaching process, such as a copper metal recovery process, is to crush mined copper mineral ore to reduce the rock particle size and expose copper mineralization. Then, the ore is transported to a heap location where it is stacked onto a leach pad. The crushed ore may go through a particle size enhancement process called agglomeration before it is transported to the heap to improve leaching efficiency. Next, a suitable acidic solution is dispensed onto the heap, and a resulting aqueous solution trickles slowly through the heap under the force of gravity to the impervious pad. This pad typically has a sloped capture-base to allow the aqueous solution to flow into collection drains for further processing, such as by a conventional, solvent extraction/electrowinning (SX/EW) process or a direct electrowinning (DEW) process.

Once ores have been subject to the energy intensive processes of crushing and agglomeration, a high percentage of the contained valuable metal can be extracted by leaching methods. While these methods are relatively effective at metal extraction, implementing improvements to traditional processing techniques to increase extraction efficiency is economically advantageous. There are many leaching process adjustments in the leaching process that may be implemented to impact extraction efficiency, including placing additives in and/or adding water to the aqueous solution, changing crush size, and injecting heat and/or air to the heap. However, in order to maximize efficiency, a real-time method of measuring the rate at which metal values are extracted (the leaching rate) of the heap, and/or monitoring outcomes from leaching operation adjustments (e.g. the amounts of additives in the aqueous solution, leaching rate, etc.) would be advantageous, but few if any such methods exist.

For example, a widely used soil moisture measurement technique, time domain reflectometry (“TDR”), uses a sensor and set of parallel prongs, which act as transmission lines, to determine the moisture content of a soil. The device produces a voltage that runs along the parallel prongs and into the soil and receives the same voltage with the sensor as it is reflected back from the soil. The speed at which the voltage travels to and from the device is correlated to the general moisture of the soil, wherein the faster the voltage travels, the drier the soil. However, such devices are not generally effective at producing consistent and real-time measurements of a leaching heap as they can only measure shallow depths, require a continuous and strong contact with the measured material, and do not work in materials with high salinity.

Typically, leaching is an open-loop controlled process, in part due to the lack of technology to measure or evaluate the process in real time. Today, there is no effective, robust real-time measurement instrumentation deployed in leach fields, and, as such, the ability to control the leaching process is hindered. The development of closed loop-control will likely improve the efficiency of leaching operations, reduce consumables, improve recovery by introducing process stability, lead to a reduction in chemical costs, and produce less variability in the final product resulting from the leaching process. Such a real-time system is needed, but not known.

### SUMMARY

Methods and systems for real-time monitoring and optimization of the heap leaching process using permittivity measurements are disclosed herein. A heap leaching monitoring and optimization system may comprise: a leaching heap, a monitoring module configured to receive a plurality of permittivity measurements, and an antenna cluster placed in the leaching heap, the antenna cluster comprising at least two antennas, wherein the antenna cluster is configured to take the plurality of permittivity measurements of the leaching heap and transmit the plurality of permittivity measurements to the monitoring module, wherein in response to receiving the plurality of permittivity measurements, the monitoring module creates an estimation of metal recovery.

In various embodiments, the antenna cluster comprises an internal antenna and two external antennas, wherein each of the internal antennas is configured to emit radio waves and each of the external antennas is configured to receive the radio waves, and wherein the antenna cluster measures the permittivity of the ore between each external antenna and the internal antenna of the antenna cluster. In various embodiments, the internal antennas emit a radio signal between 0.1 to 0.9 Watt. In various embodiments, the radio waves have a frequency on the order of about 25 kHz to about 75 MHz, preferably on the order of about 300 kHz to about 50 MHz, and more preferably on the order of about 1 MHz. In various embodiments, the internal antennas emit a power output that provides an S-parameter measurement of the permittivity of a given ore volume.

In various embodiments, the antenna cluster may be installed in leaching heaps and adjusted to find the ideal frequencies, spacing distances, antenna depth within the heaps, and number of antennas to measure the permittivity of the ore of the leaching heap based on the physical dimensions of the leaching heap. In various embodiments, there may be two or more antennas. The antennas may be configured to directly measure the permittivity of the leaching heap. The antenna configuration may be adjusted by orientation, application of the radio frequency signal, RF signal strength, and variation of antenna placement with respect to the leaching heap. In various embodiments, a receiver obtains permittivity measurements from each cluster in real time. In various embodiments, the internal antenna and the two external antennas are 5 feet long and ¾ inch in diameter and are submerged 4 feet in the leaching heap.

In various embodiments, a method for monitoring a heap leaching process may comprise: deriving a relationship between a measured permittivity of an ore and a measured metal concentration of the ore, placing a plurality of antennas configured to measure permittivity in a leaching heap of the ore, taking a plurality of permittivity measurements of the leaching heap during a leaching process, and using the derived relationship and the permittivity measurements of the leaching heap to estimate an overall metal recovery of the leaching process.

In various embodiments, the plurality of permittivity measurements is taken by a vector network analyzer. In various embodiments, the plurality of antennas comprises an internal antenna and two external antennas. In various embodiments, the measuring the permittivity further comprises: emitting, via the internal antenna, a plurality of radio waves, and receiving, via the external antennas, the plurality of radio waves.

In various embodiments, the deriving of the relationship further comprises: conducting a representative leaching process on a representative ore sample to obtain a pregnant leaching solution, taking a plurality of permittivity measurements from the representative ore sample during the representative leaching process, and correlating the plurality of permittivity measurements to the metal concentration of the pregnant leaching solution. In various embodiments, the representative leaching process is conducted on the representative ore sample in a controlled environment. In various embodiments, the representative leaching process comprises bottle roll leaching, column leaching, shake flask leaching, or leach field tests. In various embodiments, the representative leaching process is conducted for about 1 to about 30 days.

In various embodiments, the correlating comprises: receiving, by a processor, test data, wherein the test data comprises a test metal concentration dataset and a test permittivity dataset, training, by the processor, a predictive model using the historical data to create a trained predictive model, and running, by the processor, the trained predictive model to obtain a correlation. In various embodiments, the training further comprises the application of a decision tree algorithm to the predictive model.

In various embodiments, the deriving the relationship between the measured permittivity and measured metal concentration of the ore may facilitate the monitoring and optimization of the heap leaching process. In various embodiments, after the overall metal recovery of the leaching heap is determined, a leaching process modification is made, and the overall metal recovery is again calculated to determine the impact of the leaching process modification. In various embodiments, the method of obtaining permittivity measurements to estimate the overall metal recovery of the leaching heap may be repeated with the same or different leaching process modifications to optimize the leaching process.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The subject matter of the present invention is particularly pointed out and distinctly claimed in the concluding portion of the specification. A more complete understanding of the present invention, however, may best be obtained by referring to the detailed description and claims when considered in connection with the drawing figures, wherein like numerals denote like elements and wherein:

FIG. 1 illustrates an exemplary system for real-time monitoring of a leaching heap in accordance with various embodiments; and

FIG. 2 illustrates an estimation model of copper recovery produced from the instant invention compared to the real measured copper recovery values of the dataset.

### DETAILED DESCRIPTION

The present disclosure refers to and describes methods and systems for optimization of the heap leaching process using the measurement of ore permittivity. It should be appreciated that the broader process steps described herein may be accomplished by a variety of equipment configurations and sub-process steps, each of which are within the scope of the present invention. For example, the following disclosure describes using permittivity measurements to monitor and control the heap leaching process. Particular equipment is generally described as being suitable for measurements. However, other equipment may be implemented or combined with other equipment to accomplish the same function of measuring the permittivity of the material being leached and using those measurements to determine the leaching rate of the leaching heap.

Disclosed herein are systems and methods for improving the efficiency of leaching metal values in a heap leaching process. In various embodiments, the implementation of permittivity measuring devices (antennas) may enable the increase of efficiency of a heap leaching process. For example, a method of modifying the heap leaching process can be monitored for its effectiveness using real-time measurements. The real-time measurements optimize the leaching rate by identifying the leaching process modifications and magnitudes of the leaching process modifications that maximize the leaching rate. They also allow leaching process modifications to be adjusted continuously.

The real-time measurement of the leaching process is enabled by the relationship between permittivity and metal concentration. Permittivity is a material property that consists of a real component and an imaginary component, designated as ε′ and ε″ respectively. The real component is known as the “dielectric constant” and the imaginary component is known as the “loss factor.”

The loss factor is a frequency-dependent value that is directly related to the spectrum of the radio frequency field to which the material is exposed. In the low-end of the radio frequency band, the dominant influence on the loss factor is ionic conduction. These low-end radio frequency wavelengths may be monitored by one or more antennas installed into a leaching heap to measure the permittivity of the leaching heap. As the loss factor is influenced by ionic conduction, it may be correlated to the leached metal ions extracted from the ore and monitoring it may provide insight into the leaching process. Specifically, given the impact metal ions have on loss factor measurements, an inverse relationship between loss factor and remaining metal value measurements is expected. Stated another way, as the loss factor increases, metal value content remaining in the ore decreases.

Additionally, the dielectric constant can be measured and correlated to various properties in the material to be monitored. Specifically, when applied to the leaching of ore, the dielectric constant represents the interplay between the moisture of and the air gaps between the crushed ore. For example, the dielectric constant of dry ore is roughly 3 to 9, for water is roughly 70 to 80 and for air it is 1. The real time measurement of the dielectric constant can be useful for establishing the endpoint of the leaching process as when ore leaches, the physical dimensions of the ore decrease along with the corresponding amount of air gaps. By measuring the dielectric constant, the physical size of the crushed ore can be monitored until it decreases to the point when the leaching process has been completed. While neither the loss factor nor the dielectric constant is the focus of this disclosure, observing them can provide a greater understanding of the internal mechanics of the heap and a control strategy that can use either one or both of the measurements.

In various embodiments, depending on the design of the antenna and measurement device, different approaches may be used to measure scattering parameters (S-parameters). One such approach is using a corresponding equivalent electric circuit model to mimic the radio frequency (RF) behavior of the type of antenna design deployed and using that electric circuit to solve for the permittivity of the ore, based on the physical S-parameter measurements. In various embodiments, a S₁₁ parameter measurement would have a given electric circuit model, whereas a S₂₁ parameter measurement would have a different electric circuit model from a given antenna design which would have to be solved. However, both S₁₁ and S₂₁ measurements for a given antenna design and deployment demonstrate the correlation between leached ore and permittivity.

Permittivity measurements may be obtained through the use of a vector network analyzer (“VNA”) configured to measure the reflection coefficient (S₁₁) within a material at a certain frequency. The reflection coefficient, expressed as a complex value in terms of magnitude and phase, provides insights into the energy reflection characteristics of the material. While VNA's can measure impedances across a wide range of frequencies, the individual properties of various materials constrain each material to certain frequencies at which they will produce strong and consistent measurements. It is thus necessary to first calibrate the VNA to the individual material that is to be measured to determine the most advantageous frequency at which to take measurements. In the instant invention, wherein the material measured is ore, the range of frequencies resulting in sufficient data point separation and reliable measurements is on the order of about 25 kHz to about 75 MHz, preferably on the order of about 300 kHz to about 50 MHz, and more preferably on the order of about 1 MHz. In various embodiments, the VNA is a single path and one port VNA. In various embodiments, the VNA is coupled to an antenna cluster, wherein the antenna cluster is a dipole parallel transmission comprised of two external “ground” conductors and one internal “transmitting” conductor. In other embodiments, the VNA may be a two port VNA or transmission coefficient (S₂₁) measurements. In various embodiments, depending on what material property wished to be measured, any number or combination thereof of S-parameters can be measured to establish the ore properties at a given frequency.

After an S₁₁ measurement have been collected, a measured impedance can be estimated, which, in turn, can be used in combination with a Gradient Descent (GD) algorithm or other numerical methods to solve the equations and obtain relative values for the real and imaginary components of permittivity. These values exhibit correlations with the metal concentration recovered from the ore present in the PLS and can assist with the estimation of overall metal recovery from a certain leaching process. Further, it has been found that the correlation of permittivity with metal concentration presents differently between sulfide and oxide ores, allowing for a quick differentiation between the two to be obtained.

Overall metal recovery can depend on numerous factors, for example, solubility of the ore, acid volumes (and other chemical volumes), chemical additives concentration, temperature, permeability of the leaching heap. With this number of variables, it is difficult to ascertain which variables have the greatest impacts on a leaching process. Therefore, it is difficult to continuously improve the efficiency of the leaching process without knowing which modifications improved metal recovery. However, with real-time measurements enabled by corresponding permittivity measurements, a single modification may be implemented and monitored to determine the effective impact of the modification on the efficiency of the leaching process. For example, a change in the composition of the aqueous solution used for the leaching process, or a change in the amount or flow rate of the aqueous solution may be implemented and the change in permittivity can be monitored and evaluated. The benefit of measuring the impact of a single modification on metal recovery is to ascertain if the modification should be implemented to a greater magnitude or eliminated.

Thus, a method of optimizing the heap leaching process by measuring the permittivity of ore in real-time during different stages of leaching is disclosed. A correlation between the permittivity and the metal concentration of a specific type of ore may be obtained using isolated permittivity testing of the specific type of ore. In various embodiments, radio waves may be applied to the specific type of ore as it is leached with an aqueous solution, and permittivity measurements obtained over the course of the leaching process. These data points may then be used with their derived relationship to a metal concentration to predict the behavior of the leaching system.

In various embodiments, the metal concentration may be copper, iron, nickel, zinc, silver, gold, germanium, lead, arsenic, antimony, chromium, molybdenum, rhenium, tungsten, iron, ruthenium, osmium, cobalt, rhodium, iridium, palladium, platinum, uranium, or rare earth metals. In preferred embodiments, the metal concentration is copper.

When measuring permittivity of sulfide ores, the correlation of the dielectric constant (ε′) with copper concentration is linear, thus, a linear regression model can capture the dynamics of sulfide ore leaching. Conversely, when measuring permittivity of oxide ores, the correlation of the dielectric constant with copper concentration is exponential, requiring the use of a more complex regression model to predict the behavior of the oxide leaching system.

The regression models built for implementation into the monitoring system are trained using test data originating from multiple samples of the same ore type and augmented by the computation of various ratios based on copper concentration, allowing for a broad but consistent dataset that was then structured to include predictor and target variables to create a trained predictive model. In various embodiments, the test data may comprise a test metal concentration dataset and a test permittivity dataset. In various embodiments, the regression models may use a decision tree algorithm. The trained predictive model is then run with data from various experimental datasets to produce estimated copper concentration values, after which the model's estimated copper concentration values were compared with the actual measured values, allowing the regression model to be refined to improve accuracy and ultimately, obtain an accurate correlation between permittivity and copper concentration.

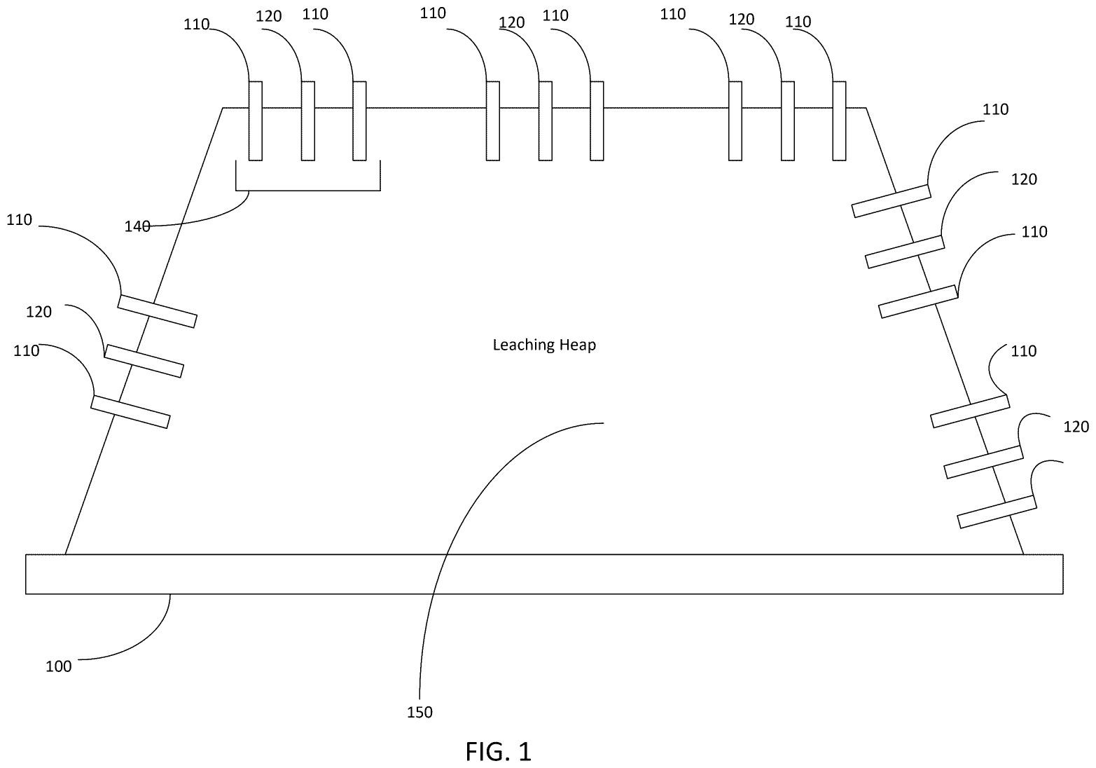

In various embodiments, a system for monitoring a leaching heap in real time may comprise a plurality of antennas that emit and receive radio waves and transmit permittivity measurements to monitor and estimate overall metal recovery of the leaching heap. Referring now to FIG. 1, a system for monitoring a leaching heap in real time is illustrated according to various embodiments of the present invention. In accordance with various aspects of the embodiments, the system may comprise: three antennas deployed into leach pad 100 forming a cluster 140. In various embodiments, cluster 140 may comprise two external “ground” antennas 110 and an internal “transmitting” antenna 120 configured in a row, with on the order of about 2 feet to about 4 feet between each. However, other distances and alternative antenna designs may prove advantageous and within the scope of this disclosure.

External antennas 110 are advantageously configured to receive permittivity measurements while internal antenna 120 is suitably configured to emit radio waves. In various embodiments, external antennas 110 and internal antenna 120 may comprise stainless steel (or other suitable metal) rod conductors having a diameter on the order of about ½ inch to about 1 inch, more preferably on the order of about ¾ inch. In various embodiments, external antennas 110 and internal antenna 120 may have a length on the order of about 2 feet to about 10 feet, more preferably on the order of about 5 feet. In various embodiments, depending on the measurement objectives of characterizing the leaching ore, external antennas 110 and internal antenna 120 may have a length greater than about 10 feet.

In various embodiments, external antennas 110 and internal antenna 120 may be inserted to different depths in leach pad 100, such as, for example, if external antennas 110 and internal antenna 120 are 5 feet long, they can be submerged approximately 4 feet into leach pad 100. In various embodiments, external antennas 110 and internal antenna 120 may be fully submerged in leach pad 100. However, any deployment depth sufficient for measuring the permittivity within the leaching heap is within the scope of this disclosure.

In various embodiments, the internal antenna 120 may emit radio waves with a wattage sufficient to obtain suitable S-parameter measurements based on the ore volume to be measured, wherein the larger the volume of ore, the greater the wattage. In various embodiments, the wattage may be on the order of about 0.1 watts to about 0.9 watts, preferably on the order of about 0.3 watts and about 0.6 watts, and more preferably on the order of about 0.5 watts. In various embodiments, the internal antenna 120 may emit frequencies in the low-end AM band on the order of about 25 kHz to about 75 MHz, preferably on the order of about 300 kHz to about 50 MHz, and more preferably on the order of about 1 MHz.

The external antennas 110 may obtain and transmit the permittivity measurements from clusters 140. These measurements may be used to calculate the metal concentration in PLS in the leaching heap 150 at the location of the cluster 140 and estimate the future behavior of the leaching system. Therefore, when a modification is made to the leaching process, the changes in the estimated metal concentration will indicate if the modification has improved, hindered, or had little to no impact on the leaching system, thereby allowing real-time modifications to be made to continuously increase the efficiency of the leaching process.

In various embodiments, a system for monitoring a heap leaching process may further comprise any number of clusters 140 sufficient to monitor the desired area. In various embodiments, the instant invention may be used to monitor a smaller section of the leaching heap 150 for a targeted assessment of the leaching rate in a precisely limited area. In these embodiments, there may be only one cluster 140 deployed in the leaching heap 150. In other embodiments, the instant invention may be used to conduct comprehensive monitoring of the entire leaching heap 150 to determine the leaching behavior of the heap as a whole. In such embodiments, such as, for example, demonstrated in FIG. 1, six sets of antenna clusters 140 may be deployed across the leaching heap 150. However, any number of clusters sufficient for monitoring a leach heap is contemplated by this disclosure. In various embodiments, the antenna clusters 140 may be placed in a variety of locations within leaching heap 150, such as, for example, on the top surface or on the side surfaces of leaching of the leaching heap 150. In various embodiments, dispersing antenna clusters 140 across leaching heap 150 may allow permittivity measurements to be more accurately obtained and may enable detection of any heterogeneity in the leaching process in different areas of the leaching heap.

In various embodiments, each cluster 140 may comprise a plurality of external antennas 110 and a plurality of internal antennas 120. In various embodiments, where fewer external antennas 110 and internal antennas 120 are deployed, the radio signal power emitted by the internal antenna 120 may be stronger. For example, wherein a cluster comprises just one external antenna 110 and one internal antenna 120, the radio signal power may be above 0.9 watts. In various embodiments, external antennas 110 and internal antennas 120 may be configured in any orientation or design sufficient to allow for the direct measurement of the leaching heap permittivity within the electric field upon an application of a radio frequency signal, such as, for example, an earth dipole or monopole antenna design.

In various embodiments, the disclosed systems and methods may further comprise a testing phase before the implementation of the antenna clusters into the leaching heap. In various embodiments, the testing may comprise taking multiple in-lab permittivity measurements over a testing period from a sample representative of the ore while it is subjected to a leaching process with an aqueous solution. In various embodiments, multiple permittivity measurements are found by measuring the reflection coefficient at applied frequencies in a range of frequencies to the leaching ore. In various embodiments, the applied frequency may be in a range on the order of about 25 kHz to about 75 MHz, preferably on the order of about 300 kHz to about 50 MHz, and more preferably on the order of about 1 MHz. In various embodiments, the permittivity measurements may be calculated from their corresponding reflection coefficient and impedance measurements. In various embodiments, a VNA may be used to measure the reflection coefficient. In various embodiments, the VNA may also be used to measure the resistive, capacitive, and inductive components of a load, as well as the frequency response. In various embodiments, leaching process may comprise bottle roll leaching, column leaching, shake flask leaching, leach field tests, or any other known leaching method. In various embodiments the testing period may be on the order of about 1 day to about 45 days or more, preferably on the order of about 1 day to about 30 days, more preferably on the order of about 20 days. In various embodiments, the testing period may be on the order of greater than about 30 days. The precise number of days may vary without departing from the scope of the invention.

Once the data from the permittivity measurements is compiled, the permittivity may be used to correlate to the metal concentration recovered from the ore in the PLS throughout the leaching process using regression modelling. Antenna clusters may then be placed in a leaching heap of the same ore to measure the permittivity during the heap leaching process. The measurements obtained from the antennas placed in the leaching heap may be monitored and recorded to determine the efficiency of the leaching heap. Then, in various embodiments, the permittivity characteristics of the characterized ore may be used to determine and estimate the overall metal recovery of the leaching heap, before and after a first leaching process modification is made to measure the impact of the leaching process modification on the leaching efficiency.

In various embodiments, the process of estimating overall metal recovery from a leaching process modification may be repeated after the application of a second leaching process modification to determine the impact of a combination thereof. In various embodiments, a second leaching process modification may comprise: a modification to the aqueous solution concentration or solution additives used in the leaching process, a modification in the application rate of the aqueous solution to the leaching heap, or a modification of the size of the crushed ore. In various embodiments, the method may be repeated multiple times with a different second leaching process modification used each time to determine both the advantages of the leaching processes alone, and in combination.

By measuring, monitoring, and predicting the overall metal recovery of the leaching heap in real time before, during, and after the addition of a leaching process modification, the impact of the leaching process modification can be obtained in real time. Further adjustments can then be made to the leaching process based on the findings. For example, if the leaching process modification is found to hinder leaching efficiency, that leaching process modification should be removed or reduced to allow for the process to run closer to optimal efficiency.

### Example 1

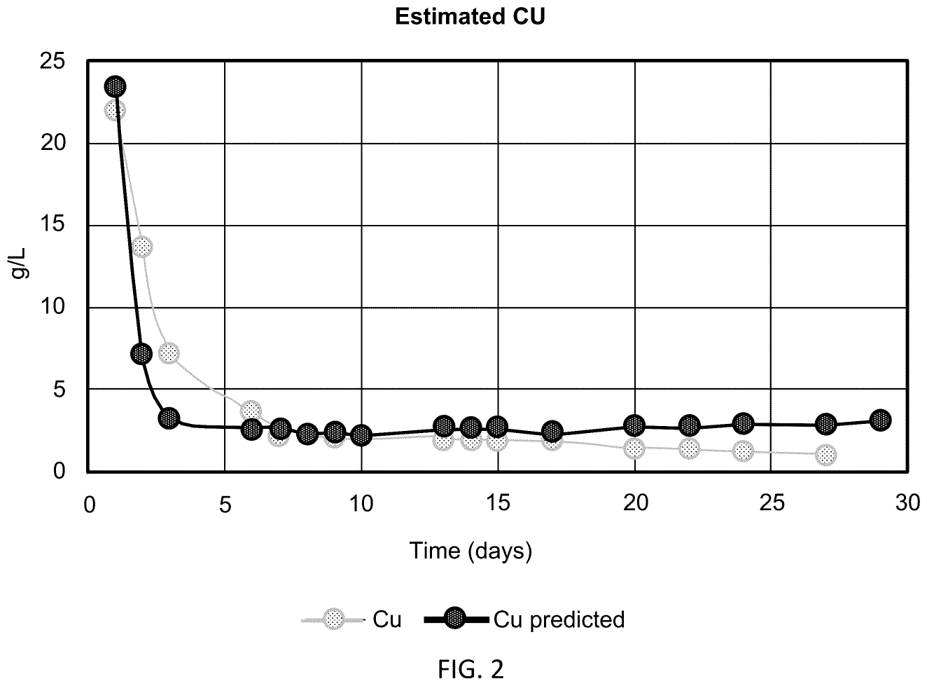

A sample of sulfide copper ore was placed in a leaching column for 30 days. An antenna cluster comprising two external “ground” conductors and one internal “transmitting” conductor was attached to the column. A radio frequency scan of 1 MHz was applied to the column through the antenna cluster and multiple reflection coefficient measurements were taken with a single port VNA. The reflection coefficient measurements were then used to derive permittivity values, following the calculation process detailed above. A regression model, built and trained as detailed above, was applied to the dataset, resulting in an estimated linear correlation with copper concentration over time. An estimated copper concentration remaining in the ore was then plotted with the actual measured copper concentration remaining in the ore to determine accuracy of the model, graphically show in in FIG. 2.

As can be seen in FIG. 2, the estimated model was accurate in predicting copper concentration, capturing the dynamics of sulfide ore leaching and enabling the prediction of future copper recovery. Even at later stages of the leaching process, the permittivity measurement is sufficiently accurate enough to retain the ability for proper control of the leaching process.

In the detailed description, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, coupled or the like may include permanent (e.g., integral), removable, temporary, partial, full, and/or any other possible attachment option. Any of the components may be coupled to each other via friction, snap, sleeves, brackets, clips or other means now known in the art or hereinafter developed. Additionally, any reference to without contact (or similar phrases) may also include reduced contact or minimal contact.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.”

All structural, and functional equivalents to the elements of the above-described various embodiments that are known to those of ordinary skill in the art are expressly incorporated herein by reference and are intended to be encompassed by the present claims. Moreover, it is not necessary for an apparatus or component of an apparatus, or method in using an apparatus to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a chemical, chemical composition, process, method, article, or apparatus that comprises a list of elements does not include only those elements but may include other elements not expressly listed or inherent to such chemical, chemical composition, process, method, article, or apparatus.

The methods and systems described herein may be implemented to improve efficiencies of heap leaching. Other advantages and features of the present systems and methods may be appreciated from the disclosure herein and the implementation of the method and system.

What is claimed is:

1. A system for real-time monitoring of a heap leaching process comprising:
a leaching heap;
a monitoring module configured to receive a plurality of permittivity measurements; and
an antenna cluster placed in the leaching heap, the antenna cluster comprising at least two antennas, wherein the antenna cluster is configured to take the plurality of permittivity measurements of the leaching heap and transmit the plurality of permittivity measurements to the monitoring module, wherein in response to receiving the plurality of permittivity measurements, the monitoring module creates an estimation of metal recovery.

2. The system of claim 1, wherein the antenna cluster comprises an internal antenna and two external antennas, wherein each of the internal antennas is configured to emit radio waves and each of the external antennas is configured to receive the radio waves, and wherein the antenna cluster measures the permittivity of the ore between each external antenna and the internal antenna of the antenna cluster.

3. The system of claim 1, wherein the estimation of metal recovery is an estimation of copper recovery.

4. The system of claim 2, wherein the internal antennas emit a radio signal between 0.1 to 0.9 Watt.

5. The system of claim 2, wherein the radio waves have a frequency between 300 kHz and 50 Mhz.

6. The system of claim 2, wherein the internal antennas emit a power output that provides an S-parameter measurement of the permittivity of a given ore volume.

7. A method for monitoring the heap leaching process, comprising:
deriving a relationship between a measured permittivity of an ore and a measured metal concentration of the ore;
placing a plurality of antennas configured to measure permittivity in a leaching heap of the ore;
taking a plurality of permittivity measurements of the leaching heap during a leaching process; and
using the derived relationship and the permittivity measurements of the leaching heap to create a predictive model of overall metal recovery of the leaching process.

8. The method of claim 7, wherein the deriving of the relationship further comprises:
conducting a representative leaching process on a representative ore sample to obtain a pregnant leaching solution;
taking a plurality of permittivity measurements from the representative ore sample during the representative leaching process;
correlating the plurality of permittivity measurements to the metal concentration of the pregnant leaching solution; and
using the predictive model to control addition or deletion of solution, reagents, acid concentration, and other process control variables.

9. The method of claim 8, wherein the representative leaching process is conducted on the representative ore sample in a controlled environment.

10. The method of claim 8, wherein the correlating comprises:
receiving, by a processor, test data, wherein the test data comprises a test metal concentration dataset and a test permittivity dataset;
training, by the processor, a predictive model using the historical data to create a trained predictive model; and
running, by the processor, the trained predictive model to obtain a correlation.

11. The method of claim 8, wherein the representative leaching process is conducted for about 1 to about 30 days.

12. The method of claim 9, wherein the representative leaching process comprises bottle roll leaching, column leaching, shake flask leaching, or leach field tests.

13. The method of claim 8, wherein the plurality of permittivity measurements is taken by a vector network analyzer.

14. The method of claim 7, wherein the plurality of antennas comprises an internal antenna and two external antennas.

15. The method of claim 14, wherein the measuring the permittivity further comprises:
emitting, via the internal antenna, a plurality of radio waves; and
receiving, via the external antennas, the plurality of radio waves.

16. The method of claim 15, wherein the internal antenna emits a radio signal between 0.1 to 0.9 Watt.

17. The method of claim 15, wherein the plurality of radio waves has a frequency between 300 kHz and 50 Mhz.

18. The method of claim 7, wherein after the overall metal recovery of the leaching heap is determined, a leaching process modification is made, and the overall metal recovery is again calculated to determine the impact of the leaching process modification.

19. The method of claim 7, wherein the metal comprises at least one of copper, iron, nickel, zinc, silver, gold, germanium, lead, arsenic, antimony, chromium, molybdenum, rhenium, tungsten, iron, ruthenium, osmium, cobalt, rhodium, iridium, palladium, platinum, uranium, or rare earth metals.

20. The method of claim 10, wherein the training further comprises applying a decision tree algorithm to the predictive model.
